(19) United States
(12) Patent Application Publication
(10) Pub. No.: US 2011/0010952 A1
(43) Pub. Date: Jan. 20, 2011

(54) Guide Bar for the Saw Chain of a Power Saw

(75) Inventor: Werner Galster, Aspach (DE)

Correspondence Address: ROBERT W. BECKER & ASSOCIATES, 707 HIGHWAY 333, SUITE B, TIJERAS, NM, 87059-7507, US

(73) Assignee: Andreas Stihl AG & Co KG, Waiblingen (DE)

(21) Appl. No.: 12/831,970

(22) Filed: Jul. 7, 2010

(30) Foreign Application Priority Data
Jul. 15, 2009 (DE) 10 2009 033 213.8

(51) Int. Cl. B27B 17/02

(52) U.S. Cl. 30/387

(57) ABSTRACT

A guide bar for the saw chain of a power saw, including an elongated, planar main body having an outer periphery that is provided with a guide groove for guiding a saw chain. A direction-changing section is disposed at a free end of the guide bar and includes two side plates. At least one rivet is provided for securing the side plates to the main body, with the rivet extending through an opening in the main body. On at least one side of the main body, the opening is provided with a flared depression for receiving an adjacent element.

The instant application should be granted the priority date of Jul. 15, 2009, the filing date of the corresponding German patent application 10 2009 033 213.8.

### BACKGROUND OF THE INVENTION

The present invention relates to a guide bar for the saw chain of a power saw, wherein the guide bar is provided with a direction-changing section at its free end.

A guide bar having a direction-changing section is known from U.S. Pat. No. 6,588,110 B2. The direction-changing section can be secured to the main body vie different types of securement means, for example via the rivet shown in this document.

The securement of the direction-changing section to a main body must, with the dynamic stresses encountered during operation, have an adequately high strength, so that the direction-changing section is always reliably held on the main body.

It is therefore an object of the present application to provide a guide bar of the aforementioned general type that achieves a good fixation of the direction-changing section on the main body, and hence an increased service life.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective illustration of a power saw,

FIG. 2 is an enlarged side view of the free end of the guide bar,

FIG. 3: is a cross-sectional view taken along the line in FIG. 2,

FIG. 4: is an enlarged illustration of the encircled portion IV in FIG. 3,

FIG. 5: is a cross-sectional illustration of the main body and one side plate during insertion of a rivet,

FIG. 6: is a cross-sectional view through one exemplary embodiment of a rivet connection,

FIG. 7: is cross-sectional view through side plate and main body during the production of the rivet connection of FIG. 6,

FIG. 8 illustrates the cross-sectional configuration of the shaft of the rivet of FIG. 7, and

FIG. 9 illustrates the cross-sectional configuration of another exemplary embodiment of the shaft of a rivet.

### SUMMARY OF THE INVENTION

The guide bar of the present application comprises: an elongated, planar main body having an outer periphery provided with a guide groove for guiding a saw chain; a direction-changing section disposed at a free end of the guide bar and including two side plates; and at least one rivet for securing the side plates to the main body, wherein the rivet extends through an opening in the main body, and the opening, on at least one side of the main body, is provided with a flared depression for receiving an adjacent element.

It has been shown that the known rivet connections can become loose due to the stresses that occur during operation, so that the guide bar can no longer be used. To prevent this loosening of the rivet connections, it is proposed pursuant to the present application to provide not only just a positive connection, but also a form-locking connection, between the rivet or the side plate and the main body. As a result, the strength of the connection is increased.

A head of the flush rivet advantageously extends into the flared depression. As a result, the contact or support surface of the rivet is increased, and at the same time a form-locking or positively-engaging connection is established between rivet and main body. In this connection, the head of the rivet advantageously rests against the depression. The opening angle of the depression corresponds in particular to the head angle of the head, thus achieving a large contact surface of the head against the depression. The depression expediently has an opening angle of approximately 60°. The depth of the depression in the main body is approximately one half to approximately one fourth, in particular approximately one third, of the thickness of the main body adjacent to the opening. In this connection, the thickness of the main body at the attachment or securement end of the guide bar to the power saw can be significantly greater than the thickness in the region where the side plates rest against it.

The adjacent element, which is received by or extends into the depression, can be a side plate, which is in particular provided with a collar that extends into the depression. In this connection, the collar is advantageously a punch collar at the rivet opening in the side plate. This punch collar can simply be produced along with the punching of the rivet opening, or a punch collar that results anyway need not be removed. In this connection, the depression advantageously has an opening angle of about 90°. The depth of the depression is here advantageously from approximately 0.2 mm to approximately 1 mm, in particular approximately 0.5 mm. The thickness of the collar advantageously corresponds approximately to the depth of the depression, so that the collar can be completely accommodated in the depression.

A guide star, which is mounted so as to be rotatable about an axis of rotation, is disposed between the side plates.

An independent inventive concept relates to the arrangement of the rivet on the guide bar. With heretofore known guide bars, if three rivets are provided customarily one rivet is disposed at that end that faces the attachment end of the guide bar, and two rivets are provided adjacent to the guide star. It has been shown that by providing a different arrangement of the rivets, the moment that is to be absorbed by the rivets can be significantly increased. Advantageously, exactly three rivets are provided for the securement of the side plates, wherein a first rivet is disposed at a first distance relative to the axis of rotation of the guide star as measured in the direction of the longitudinal central axis, and two rivets are disposed at a second, greater distance.

A further independent inventive concept relates to an arrangement of the rivets that is secure against rotation. In order in a straightforward manner to achieve an arrangement that is secure against rotation, the shaft of at least one of the rivets has a non round cross-sectional configuration, and the opening of the main body has a corresponding cross-sectional configuration. A straightforward design results if the shaft has at least one raised portion that extends in the longitudinal direction of the shaft. The shaft expediently has a star shaped cross-sectional configuration. However, other non round cross-sectional shapes can also be advantageous. Furthermore, as an alternative, or in addition to the preceding, it is also possible for at least one head of a rivet to have a non round cross-sectional configuration, with the depression of the main body and/or the rivet opening of the side plate having a corresponding cross-sectional configuration. Also in this way it is possible, in a straightforward manner, to achieve an arrangement of the rivet that is secure against rotation. In this connection, the securement against rotation can already be provided in the rivet and/or in the side plate or the main body prior to assembly, or can be formed during the assembly and deformation of the rivet.

Further specific features of the present application will be described subsequently in conjunction with exemplary embodiments of the invention.

### DESCRIPTION OF SPECIFIC EMBODIMENTS

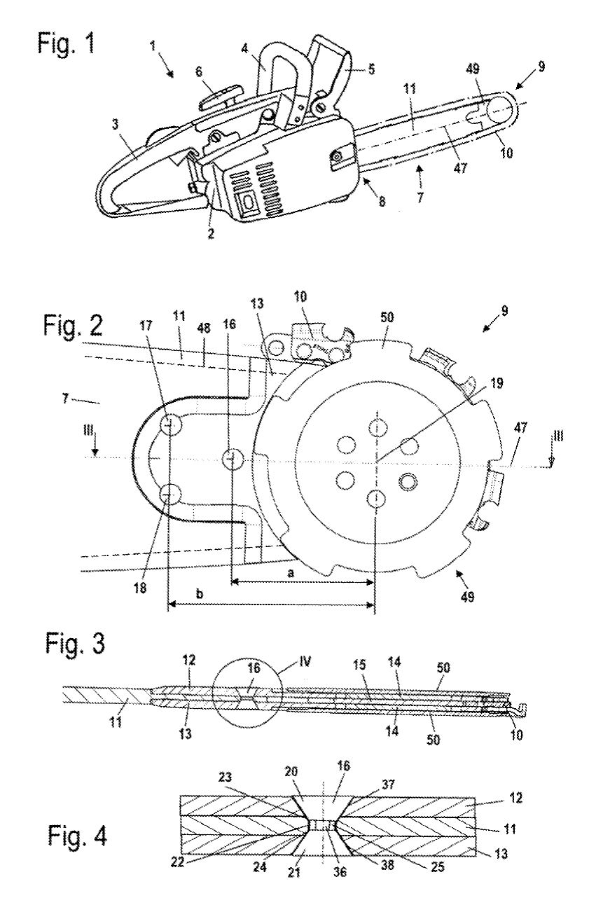

Referring now to the drawings in detail, FIG. 1 shows a power saw 1, which has a housing 2. Disposed in the housing 2 is a drive motor, which in the illustrated embodiment is an internal combustion engine that is started by a starter or pull handle 6. The internal combustion engine is advantageously a single cylinder, two-cycle engine, or a mixture-lubricated, four-cycle engine. However, an electric motor can also be provided as the drive motor. A rear handle 3 and a tubular handle 4 are mounted on the housing 2 for guiding the power saw 1. On that side of the housing 2 that faces away from the rear handle 3, a guide bar 7 extends toward the front. A saw chain 10, which is schematically illustrated in FIG. 1, is disposed on the guide bar 7 in such a way that it circulates thereon. The saw chain 10 is circulated by the drive motor. On that side of the tubular handle 4 that faces the guide bar 7 a finger guard 5 is disposed on the housing 2 for actuating a chain braking mechanism.

The guide bar 7 is secured to the housing 2 via a securement end 8, and has a free end 9 on which is disposed a direction-changing section 49. The guide bar 7 has a planar, elongated main body 11, and a longitudinal central axis 47.

FIG. 2 is an enlarged illustration of the free end 9 of the guide bar 7. The main body 11, on its outer periphery, has a circumferential guide groove 48 in which the saw chain 10 is guided. As also shown in FIG. 3, two side plates 12, 13 are secured to the main body 11 and, together with a guide star 15 that is disposed between the side plates 12, 13, form the direction-changing section 49. In the region of the guide star 15, respective guide plates 50 are disposed on the outer sides of the side plates 12 and 13 for laterally guiding the saw chain 10.

The two side plates 12 and 13 are fixed to the main body 11 by means of three flush rivets 16, 17 and 18. A first flush rivet 16 is disposed adjacent to the guide star 15 in the region of the longitudinal central axis 47 (see FIG. 2). This first flush rivet 16 is spaced by a distance a relative to the axis of rotation 19 of the guide star 15. The two other flush rivets 17 and 18 are disposed on opposite sides of the longitudinal central axis 47 and at a distance b relative to the axis of rotation 19. In this connection, the distances a and b are measured in the direction of the longitudinal central axis 47. The distance b of the flush rivets 17 and 18 is significantly greater than the distance a of the flush rivet 16 relative to the axis of rotation 19. The flush rivets 16, 17 and 18 can approximately form the corners of an equilateral triangle. The illustrated arrangement of the three flush rivets 16, 17 and 18 results in a good securement of the side plates 12 and 13 to the main body 11, since moments that are introduced can be well absorbed. The illustrated arrangement of the three flush rivets 16, 17 and 18 represents an independent inventive concept that can be advantageous regardless of the type of rivet that is used.

As shown in FIG. 3, disposed on both sides of the guide star 15 in the region of the side plates 12 and 13 are mounting or support means 14 that hold the guide star 15 in a rotatable manner.

FIG. 4 shows the flush rivet 16 in detail. The flush rivet 16 has two heads 20 and 21, which are interconnected via a shaft 25. The shaft 25 extends in the region of the main body 11, and extends into the main body 11 through an opening 22. As shown in FIG. 4, the heads 20 and 21 extend into the region of the main body 11. On that side facing the head 20, the main body 11 has a first flared depression 23, and on the opposite side that faces the head 21, the main body 11 has a second flared depression 24. The head 20 extends into the depression 23, and the head 21 extends into the depression 24. This results in a positive or form fitting connection between the main body 11 and the rivet 16. The heads 20 and 21 are flush and tight with the outer sides of the side plates 12 and 13. The heads 20 and 21 have the shape of a truncated cone, and their entire peripheral surfaces rest against the side plates 12, 13 or the flared depressions 23 and 24 of the main body 11.

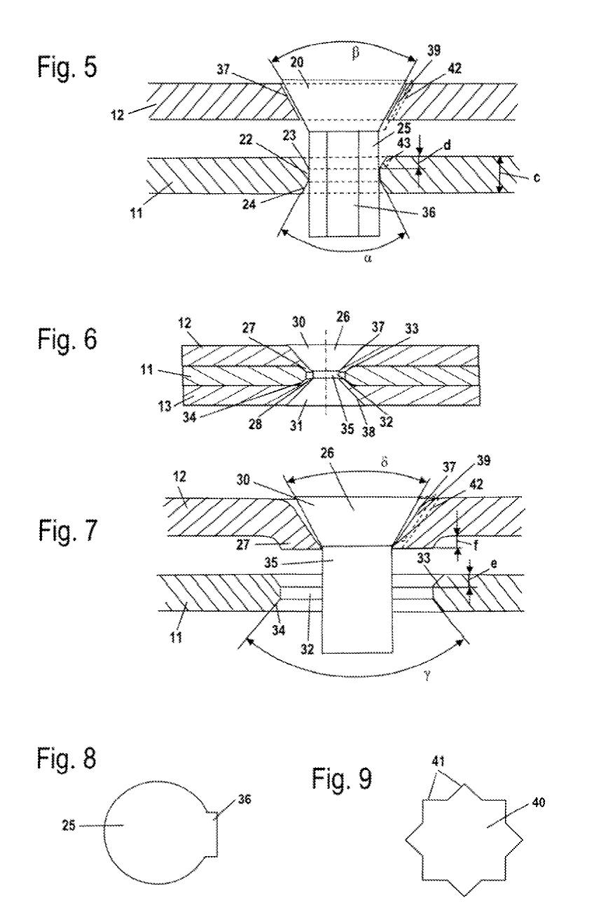

FIG. 5 shows the rivet connection in detail. Here, the head 21, which is embodied as a closing head, and the side plate 13, are not shown. The head 20 has a head angle β that is advantageously approximately 60°. The depressions 23 and 24 have an opening angle α that corresponds to the head angle β and that in the illustrated embodiment is also 60°. The depressions 23 and 24 are embodied such that the greatest diameter corresponds to the smallest diameter of the rivet opening 37 in the side plate 12 and the rivet opening 38 in the side plate 13 (shown in FIG. 4). The depth d of the depressions 23 and 24 advantageously corresponds to approximately half to approximately one fourth, in particular approximately one third, of the thickness c of the main body 11 in the region against which the side plates 12 and 13 rest.

A further exemplary embodiment of a rivet connection having a flush rivet 26 is shown in FIGS. 6 and 7. The rivet 26 has a first head 30 and a second head 31, which extend into the region of the main body 11, and a shaft 35, which extends through an opening 32 in the main body 11. The side or main plates 12 and 13 are provided at the rivet openings 37 and 38 with respective collars 27 and 28, which extend in the direction toward the main body 11. The collars 27 and 28 can, for example, be punch collars and are generated during the punching process with which the rivet openings 37 and 38 are produced. The main body 11 has a flared depression 33 on that side that faces the side plate 12, and a flared depression 34 on the opposite side. The opening angle γ of the depressions 33 and 34 is advantageously approximately 90°. The depressions 34 and 33 are formed at an opening 32 in the main body 11 and have a depth e, which is advantageously approximately 0.2 mm to approximately 1 mm, and in particular approximately 0.5 mm. The thickness f of the collars 27 and 28 is similarly also advantageously approximately 0.2 mm to approximately 1 mm, and in particular approximately 0.5 mm. In this connection, the thickness f of the collars 27 and 28 is adapted to the depth e of the depressions 33 and 34, resulting in a positive or form fitting connection between the side plates 12, 13 and the main body 11. The head angle δ of the heads 30 and 31 advantageously corresponds approximately to the opening angle γ of the depression 33 and 34, and is in particular approximately 90°. This angle advantageously also corresponds to the opening angle of the rivet openings 37 and 38, so that the head 30 and the head 31 rest completely against the rivet openings 37 and 38, thus resulting in a good, large abutment or contact surface of the heads 30 and 31.

To achieve a securement of the rivet 16 against rotation in a straightforward manner, a raised portion 36 is provided on the shaft 25 of the rivet 16 (shown in FIGS. 4, 5 and 8). The raised portion 36 extends into a corresponding recess on the main body 11 and thereby prevents rotation of the rivet 16. Instead of the shaft 25 with the raised portion 36, the shaft 40 shown in FIG. 9 could also be provided. The shaft 40 has a star-shaped cross-sectional configuration, and is provided with a plurality of teeth 41 that cooperate with a corresponding cross-sectional configuration of the opening 22. Other non round cross-sectional configurations of the shaft 25, 40 could also be advantageous. Instead of a shaft 25, 40 that is not round, it would also be possible to make the cross-sectional configuration of the head 20 non round. For this purpose, a raised portion 39, as shown in dashed lines in FIG. 5, could be provided on the head 20 in addition to or instead of the raised portion 36 on the shaft 25. The raised portion 39 extends into a recessed portion 42 at the rivet opening 37 (also shown by dashed lines in FIG. 5). Instead of a raised portion, the head could also be provided with a recessed portion, into which then a corresponding projection on the rivet opening 37 would extend. In a corresponding manner, raised portions or recessed portions could also be provided on the depression 23, which would then cooperate with a corresponding recess or raised portion 39 on the head 20. For this purpose, a recessed portion 43 is schematically shown on the depression 23 in FIG. 5, again by dashed lines.

The non round or non circular configurations provided at the rivet opening 37, the depression 23, the head 20 and the shaft 25 can be provided in the rivet and/or in the main body 11 or in the side plate 12 either prior to assembly or only upon the deformation during the assembly. Corresponding non round configurations can be provided at the side plate 13 and/or the second head 21 of the rivet 16. The securement against rotation of a rivet 16 that is provided represents an independent inventive concept, and contributes to an improvement of the connection of the direction-changing section 49 to the main body 11. A corresponding securement against rotation having a raised portion 39 on the head 26 and a recessed portion 42 on the rivet opening 37 can also be provided with the embodiment of FIG. 7, and is also shown here in dashed lines.

In the embodiment of FIGS. 3 and 4, the height of the rivet head 20, 21 is greater than the thickness of the side plates 12, 13. In the embodiment of FIGS. 6 and 7, the height of the rivet head can be greater than the thickness of the side plates. However, the height of the rivet head can also correspond approximately to the thickness of the side plates 12, 13. The main body 11 of the guide bar can be a monolithic component or can be built up of several components.

The specification incorporates by reference the disclosure of Germany priority document 10 2009 033 213.8 filed Jul. 15, 2009.

The present invention is, of course, in no way restricted to the specific disclosure of the specification and drawings, but also encompasses any modifications within the scope of the appended claims.

What I claim is:

1. A guide bar for the saw chain of a power saw, comprising:
an elongated, planar main body, wherein said main body has an outer periphery provided with a guide groove for guiding a saw chain;
a direction-changing section disposed at a free end of said guide bar, wherein said direction-changing section includes two side plates; and
at least one rivet for securing said side plates to said main body, wherein said at least one rivet extends through an opening in said main body, and wherein said opening, on at least one side of said main body, is provided with a flared depression for receiving an adjacent element.

2. A guide bar according to claim 1, wherein said adjacent element is a head of said at least one rivet.

3. A guide bar according to claim 2, wherein said head rests against said depression.

4. A guide bar according to claim 2, wherein an opening angle of said depression corresponds to a head angle of said head.

5. A guide bar according to claim 3, wherein said depression has an opening angle of approximately 60°.

6. A guide bar according to claim 1, wherein a depth of said depression in said main body is approximately one half to approximately one fourth, in particular approximately one third, of a thickness of said main body adjacent to said opening.

7. A guide bar according to claim 1, wherein said adjacent element is one of said side plates and wherein said side plate is provided with a collar configured to extend into said depression.

8. A guide bar according to claim 7, wherein said collar is a punch collar at a rivet opening provided in said side plate.

9. A guide bar according to claim 7, wherein said depression has an opening angle of approximately 90°.

10. A guide bar according to claim 7, wherein said depression has a depth of approximately 0.2 mm to approximately 1 mm.

11. A guide bar according to claim 10, wherein said depression has a depth of approximately 0.5 mm.

12. A guide bar according to claim 7, wherein a thickness of said collar corresponds approximately to a depth of said depression.

13. A guide bar according to claim 1, wherein said opening in said main body is provided with a respective depression on each side of said main body, and wherein a respective adjacent element extends into each of said depressions.

14. A guide bar according to claim 1, wherein a guide star is disposed between said side plates, and wherein said guide star is mounted so as to be rotatable about an axis of rotation.

15. A guide bar according to claim 14, wherein precisely three rivets are provided for securement of said side plates, further wherein a first one of said rivets is disposed at a first distance relative to said axis of rotation of said guide star, as measured in the direction of a longitudinal central axis of said guide bar further wherein two of said rivets are disposed at a second distance relative to said axis of rotation of said guide star, and wherein said second distance is greater than said first distance.

16. A guide bar according to claim 1, wherein a shaft of one of said rivets has a non round cross-sectional configuration, and wherein said opening of said main body has a corresponding cross-sectional configuration.

17. A guide bar according to claim 16, wherein said shaft is provided with at least one raised portion that extends in the longitudinal direction of said shaft.

18. A guide bar according to claim 17, wherein said cross-sectional configuration of said shaft is star shaped.

19. A guide bar according to claim 1, wherein at least one head of at least one rivet is provided with a non round cross-sectional configuration, and wherein said depression of said main body has a corresponding cross-sectional configuration.

20. A guide bar according to claim 1, wherein at least one head of at least one rivet has a non round cross-sectional configuration, and wherein an associated rivet opening of one of said side plates has a corresponding cross-sectional configuration.
